(19) United States
(12) Patent Application Publication
(10) Pub. No.: US 2021/0295193 A1
(43) Pub. Date: Sep. 23, 2021

(54) Continuous Restricted Boltzmann Machines

(71) Applicant: Georgia State University Research Foundation, Inc., Atlanta, GA (US)

(72) Inventor: Robert W. Harrison, Atlanta, GA (US)

(21) Appl. No.: 17/265,395

(22) PCT Filed: Aug. 30, 2019
(86) PCT No.: PCT/US2019/048963

§ 371 Date: Feb. 2, 2021

Related U.S. Application Data
(60) Provisional application No. 62/724,655, filed on Aug. 30, 2018.

(51) Int. Cl. G06N 7/08; G06N 20/00; G06K 9/62

(52) U.S. Cl. CPC G06N 7/08; G06K 9/6256; G06N 20/00

(57) ABSTRACT

Embodiments of the present systems and methods may provide techniques for deterministic training of cRBMs. Embodiments may utilize least square error estimates for the hidden variables, which is computationally tractable and provides improved results. For example, in an embodiment, a computer-implemented method for machine learning may comprise generating a continuous restricted Boltzman machine model by replacing discrete valued spins in a discrete restricted Boltzman machine model with continuous values, training the continuous restricted Boltzman machine model using a training dataset using a deterministic training process having hidden variables defined using least square error estimates, and using the trained continuous restricted Boltzman machine model to recognize patterns in new data.

### STATEMENT REGARDING FEDERALLY SPONSORED RESEARCH

This invention was made with government support under Grant GM062920 awarded by National Institute of Health. The government has certain rights in the invention.

### BACKGROUND

The present invention relates to techniques for generating and training continuous restricted Boltzmann machines.

Restricted Boltzmann machines (RBMs) are a type of generative neural network. They summarize their input data to build a probabilistic model that can then be used to reconstruct missing data or to classify new data. Unlike discrete Boltzmann machines, where the data are mapped to the space of integers or bitstrings, continuous Boltzmann machines directly use floating point numbers and therefore represent the data with higher fidelity. The primary limitation in using Boltzmann machines for big-data problems is the efficiency of the training algorithm.

Restricted Boltzmann machines develop an energy-based model of the data presented to them. Since RBMs learn to recognize the data they have seen, they are well-suited to extracting and reconstructing consistent patterns in data. In a very real sense they straddle the divide between unsupervised and supervised learning algorithms. Because they are regenerative, they are also a prototype of deep learning, and can serve as an “adapter” between real data and a more abstract representation suitable for other machine learning approaches. RBMs are inherently probabilistic recognizers and can interface effectively with fuzzy representations of uncertainty.

The classic or discrete RBM (dRBM) restricts the input and output data to integer values or bitstrings. Real valued data typically are mapped to unique bit-strings. This results in a loss of fidelity in the reconstruction because only the bitstring can be reproduced. The encoding or mapping is also problem-dependent and the use of a sub-optimal encoding will result in sub-optimal training, classification, and reconstruction.

Continuous RBMs (cRBM) replace discrete valued spins with continuous values. The problem of training an RBM shifts from enumerating independent spins to estimating the continuous values of the hidden variables. However, issues still arise with the training of such cRBMs. A need arises for improved techniques for training cRBMs.

### SUMMARY

Embodiments of the present systems and methods may provide techniques for deterministic training of cRBMs. Embodiments may utilize least square error estimates for the hidden variables, which is computationally tractable and provides improved results.

For example, in an embodiment, a computer-implemented method for machine learning may comprise generating a continuous restricted Boltzman machine model by replacing discrete valued spins in a discrete restricted Boltzman machine model with continuous values, training the continuous restricted Boltzman machine model using a training dataset using a deterministic training process having hidden variables defined using least square error estimates, and using the trained continuous restricted Boltzman machine model to recognize patterns in new data.

In embodiments, training the continuous restricted Boltzman machine model may comprise generating initial values of weights of the continuous restricted Boltzman machine model, generating initial values of the hidden variables based on the training dataset and visible values, updating the values of the hidden variables based on a least squares error estimate of a distance from each hidden value to a predicted value of the hidden value and a visible value, given the weights; and updating the weights using an integral over changes in potential. The expected value of the shift in weights over changes in potential may be approximated by:

$$〈 \frac{d U}{dW} 〉 = dW \frac{3 {e}^{- β U ( W + d W )}}{{e}^{- β U ( W - dW )} + {e}^{- β U ( W )} + {e}^{- β U ( w + d W )}} ,$$

where W are the weights.

In an embodiment, a system for machine learning may comprise a processor, memory accessible by the processor, and computer program instructions stored in the memory and executable by the processor to perform generating a continuous restricted Boltzman machine model by replacing discrete valued spins in a discrete restricted Boltzman machine model with continuous values, training the continuous restricted Boltzman machine model using a training dataset using a deterministic training process having hidden variables defined using least square error estimates, and using the trained continuous restricted Boltzman machine model to recognize patterns in new data.

In an embodiment, a computer program product for machine learning may comprise a non-transitory computer readable storage having program instructions embodied therewith, the program instructions executable by a computer, to cause the computer to perform a method comprising generating a continuous restricted Boltzman machine model by replacing discrete valued spins in a discrete restricted Boltzman machine model with continuous values, training the continuous restricted Boltzman machine model using a training dataset using a deterministic training process having hidden variables defined using least square error estimates, and using the trained continuous restricted Boltzman machine model to recognize patterns in new data.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary pseudocode listing of a method of performing cRBM training, in accordance with embodiments of the present systems and methods.

FIG. 2 is an exemplary pseudocode listing of a method of performing classifier training, in accordance with embodiments of the present systems and methods.

FIG. 3 shows an example of the quality (accuracy) of the reconstruction with a cRBM, according to embodiments of the present systems and methods, as a function of the number of hidden layers.

FIG. 4 is an exemplary block diagram of a computer system in which processes involved in the embodiments described herein may be implemented.

### DETAILED DESCRIPTION

Embodiments of the present systems and methods may provide techniques for deterministic training of cRBMs. Embodiments may utilize least square error estimates for the hidden variables, which is computationally tractable and provides improved results.

In embodiments, an RBM may train or optimize a potential against data. A full discrete Boltzmann machine uses a spin-lattice construct of hidden variables to enumerate states and seeks to find an energy minimum over that lattice given an observed set of data. Since the number of possible states of the spin-lattice is exponential, simplifications such as the RBM have been developed. In embodiments, an RBM may use a layer of independent hidden variables and thus the number of possible states may be a linear function of the number of hidden variables. Conventional RBMs use an iterative stochastic optimization algorithm, contrastive divergence, for training.

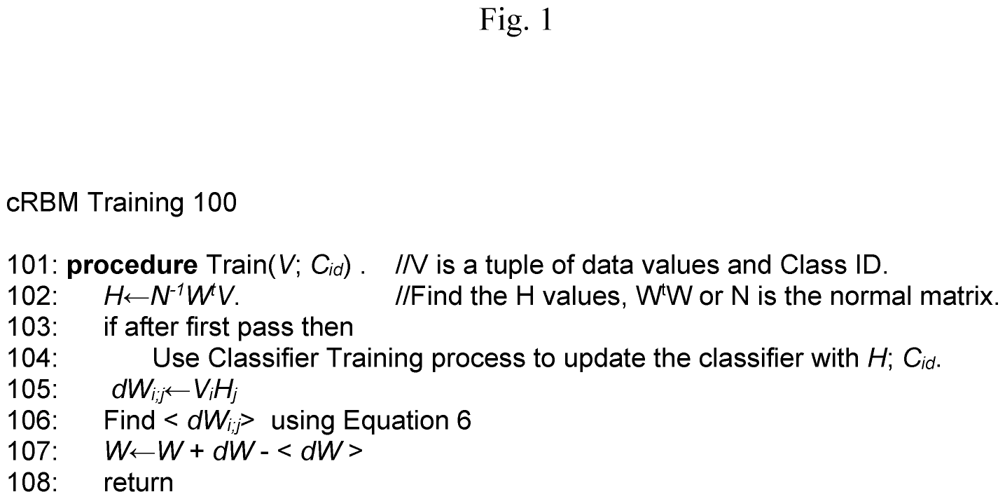

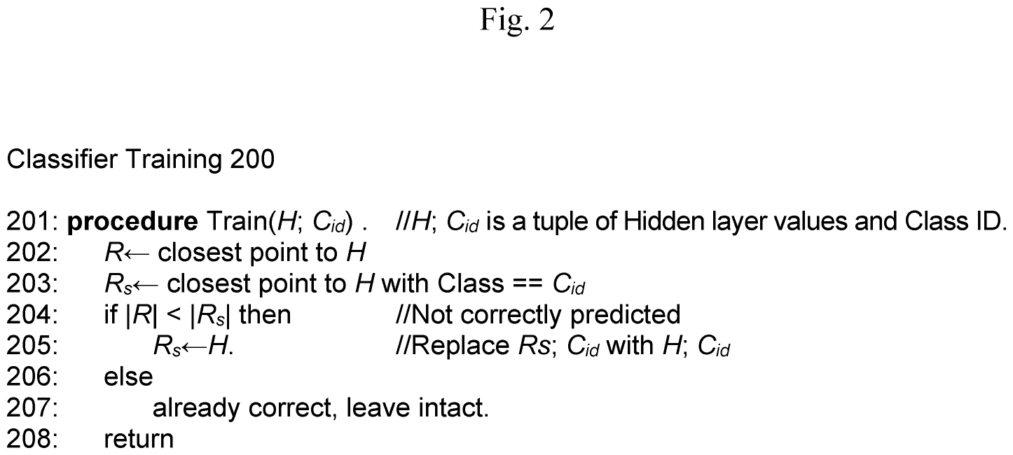

In embodiments, the present systems and methods may replace the stochastic algorithm with an analytic approximation, which results in considerable simplifications to the method. An example of an embodiment of a method of cRBM Training using analytic approximation is shown in FIG. 1. Shown in this example is a pseudocode procedure 101 for training a cRBM, which accepts as inputs a tuple of data values V and a Class ID, C_{id}. At 102, the H values (the hidden values) may be found based on a normal matrix N, which is a symmetric, diagonally dominant, matrix, the weight W, and the input tuple V. At 103, if the process is on a pass other than the first pass (after the first pass), then, at 104, the Classifier Training process 200, shown in FIG. 2, may be used to update the classifier with H; C_{id}. At 105, dW_{i:j}←VᵢHⱼ. At 106, the expected value of dW_{i:j} may be found using Equation 6 below. At 107, the weight W may be updated according to W+dW−<dW>.

The formal background of the algorithm for a continuous Boltzmann machine starts from the definition of the potential energy:

$$U = {\sum }_{i} {\sum }_{j} {V}_{i} {W}_{i , j} {H}_{j} = {V}^{t} WU \qquad ( 1 )$$

Where Vᵢ are the observed data, W_{i,j} are the weights and Hⱼ are the hidden values. A bias could be added to both the observed data and hidden values. However, since the bias is colinear with the data and hidden values, it may be set to a constant of zero. Adding a bias would replace Hⱼ with (Hⱼ−bhⱼ) and Vᵢ with (Vᵢ−bvᵢ) where bh and bv are hidden and visible layer bias values, respectively. The free energy is by definition and as an analogy the Helmholtz free energy in statistical mechanics:

$$F = \frac{- 1}{β} ln ( {\sum }_{samples} {e}^{- β U} ) \qquad ( 2 )$$

The partition function Z is defined as

$${\sum }_{samples} {e}^{- β U} ,$$

and the probability of any one state is given by

$$\frac{{e}^{- β U}}{Z} .$$

Taking the derivative of F yields the probability:

$$\frac{d F}{d {U}_{i}} = \frac{1}{{Z}^{e}} {e}^{- β {U}_{i}} = P ( {U}_{i} )$$

thus by the chain rule, the derivative of F with respect to a parameter p is:

$$\frac{dF}{dp} = {\sum }_{j} \frac{df}{{dU}_{i}} \frac{{dU}_{i}}{dp} = {\sum }_{i} {P}_{i} \frac{{dU}_{i}}{dp} = 〈 \frac{{dU}_{i}}{dp} 〉 \qquad ( 4 )$$

where < > denotes expected value. Maximizing U to train and minimizing F to prevent over-training results in the total derivative

$$\frac{dU}{dp} - \frac{dF}{dp} or \frac{dU}{dp} - 〈 \frac{dU}{dp} 〉 .$$

Taking the derivative of U−F with respect to W_{i,j} results in:

$${\sum }_{i} {\sum }_{j} {V}_{i} {H}_{j} - 〈 {\sum }_{i} {\sum }_{j} {V}_{i} {H}_{j} 〉 = {V}^{t} H - 〈 {V}^{t} H 〉 \qquad ( 5 )$$

which encapsulated Hebbian learning in the correlation between V and H.

Two major difficulties arise in the use of equation 5. The first is the evaluation of the expected value term and the second is the evaluation of Hⱼ. Contrastive divergence finds a numerical approximation for

$$〈 \frac{dU}{dW} 〉 .$$

Moving from the discrete model to a continuous model requires shifting from a sum over two states (spins of ±1) to an integral over the changes in potential. Numerical approximations readily converge for this integral and we use:

$$〈 \frac{d U}{dW} 〉 = dW \frac{3 {e}^{- β U ( W + d W )}}{{e}^{- β U ( W - dW )} + {e}^{- β U ( W )} + {e}^{- β U ( w + d W )}} \qquad ( 6 )$$

where dW_{i,j} is VᵢHⱼ.

Evaluating Hⱼ is more difficult. Naively using the gradient

$$\frac{dU}{{dH}_{j}} = {\sum }_{i} {V}_{i} {W}_{i , j}$$

to estimate H tends to lose information and converge to a uniform set of weights. Forming the least squares estimate that matches H and V given W gives far better results. The rows of W form a basis set for expanding Vin the least squares algorithm.

$$\begin{matrix}\frac{d U}{d V} = {\sum }_{j} {W}_{i , j} {H}_{j} & ( 7 ) \\ {V}_{calc} = δ \frac{dU}{dV} & ( 8 ) \\ minimize Q = {( V - {V}_{calc} )}^{2} over H & ( 9 ) \\ \frac{dQ}{dH} = - 2 ( V - {V}_{calc} ) \frac{dU}{dH} = 0 at the minimum . & ( 10 )\end{matrix}$$

Where N is the normal equation of the system. N is a symmetric, diagonally dominant, matrix. During training, N may be ill-conditioned, so as a practical matter, it is regularized by adding λI. In embodiments, λ=1 and the magnitude of the elements of N may be typically about 100-1000. In embodiments, the pseudocode shown in FIGS. 1 and 2 may solve the normal equation with Gaussian elimination every time H is generated. In embodiments, production code may save time by either storing N⁻¹ or using an LU decomposition. This approach is a version of the Levenberg-Marquardt algorithm applied to training. In embodiments, other approaches to accelerating the calculation may be used.

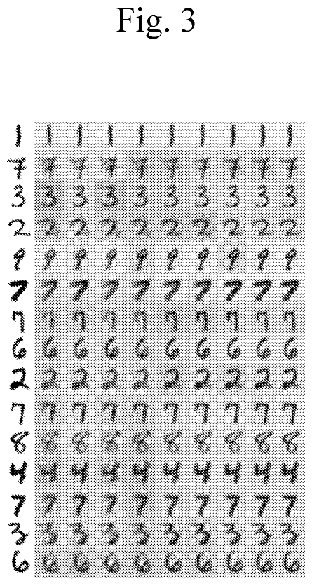

FIG. 3 shows the quality of reconstructions when applied to the MNIST data set.

Classification Algorithm. The values of the energy and the quality of the reconstruction are poor predictors of class membership with cRBMs. In essence, the reconstruction algorithm is too good for the errors to be a reliable indicator of class membership. Since the rows of W are a basis set and H is the expansion of the data in that basis, the values of H are useful for classifying data. Since the rank of W is often lower than the number of features or the number of features times the number of classes, the values of H are a compressed representation of the data. FIG. 2 shows an example of a classifier training process 200, which may be used to train the classifier. It selects points that are along the boundary between classes. Process 200 begins with 201, in which the inputs H; C_{id}, in which H is a tuple of Hidden layer values and C_{id} is the Class ID. At 202, R is updated with the closest point to H. At 203, R is updated with the closest point to H with Class==C_{id}. At 204, if the absolute value of R is less than the absolute value of Rₛ, then the prediction is not correct and, at 205, Rs; C_{id} may be replaced with H; C_{id}. If, at 204, the absolute value of R is not less than the absolute value of Rₛ, then the prediction is already correct, and at 206, 207, Rs; C_{id} is left intact.

Exemplary Results. Table 1 shows an example of Benchmark Results of the performance of this cRBM tested against standard datasets. This example, shows the performance of the cRBM on a range of problems taken from the UCI repository. In this example, the best results for the dRBMs, after optimizing the encoding to discrete bitstrings, were included in the table. The prescribed training and test sets were used for all of the UCI datasets and the others were evaluated with five-fold cross validation with the mean accuracy reported. The new algorithm consistently out-performs the older ones. While not shown, the PPV, recall and F-scores are consistent with the level of accuracy in the results. The correlation between the reconstructed data, determined by equation 8 and the input data is >0.99 for most of the data sets. (TPV is an exception where it is only >0.9).

TABLE 1

| Benchmark | Scale | Size, Classes | FDT | FDT2 | dRBM | cRBM |
|---|---|---|---|---|---|---|
| Iris | S | 36, 3 | 97.2 | 91.67 | 91.7 | 100. |
| Bupa | S | 86, 2 | 54.7 | ND | 64 | 67.4 |
| Wdbc | S | 142, 2 | 95.1 | ND | 95.1 | 95.8 |
| Ecoli | S | 170, 7 | 79.4 | ND | 74.7 | 78.2 |
| sRNA | S | 452, 2 | 48.7 | 71.7 | 58.6 | 79.9 |
| Image | S | 574, 7 | 91.5 | ND | 92 | 95.3 |
| microRNA | M | 1106, 2 | 85.7 | 82.5 | 87.1 | 89.4 |
| Shuttle | L | 58000, 9 | ND | 83.7 | ND | 83.4 |
| TPV | L | 10300, 2 | Fail | 99.5 | 98.7 | 97.7 |

An example of benchmarking embodiments of the present techniques against HIVpr drug resistance data of a previous approach are shown in Table 2. This example demonstrates embodiments of the present techniques can handle relatively large datasets. In this example, the previous approach maps drug resistant mutations onto the molecular structure and uses Delaunay triangulation to reduce it to a 210 long feature vector. The previous approach used compressed encoding, as well as SVM and ANN, so it is a relevant comparison. The average values for 5-fold cross validation using 10 hidden layers and standard errors are reported for this data. The data used included between 10000 and 17000 data points.

TABLE 2

| | Yu | | | | |
|---|---|---|---|---|---|
| Inhibitor | Accuracy | Accuracy | PPV | Recall | F |
| idv | 96.1 | 94.8 ± 0.1 | 94.1 ± 0.9 | 92.9 ± 1.0 | 93.4 ± 0.2 |
| lpv | 95.9 | 95.1 ± 0.3 | 95.5 ± 0.3 | 93.0 ± 0.8 | 94.2 ± 0.4 |
| sqv | 95.0 | 93.6 ± 0.3 | 95.8 ± 0.2 | 91.9 ± 0.8 | 93.8 ± 0.4 |
| tpv | 96.1 | 97.7 ± 0.2 | 98.2 ± 0.2 | 97.8 ± 0.1 | 98.0 ± 0.2 |

The MNIST character recognition data set consists of 60,000 scanned and centered handwritten digits for training and 10,000 digits for testing. FIG. 3 shows an example of the quality (accuracy) of the reconstruction with a cRBM, according to embodiments of the present systems and methods, as a function of the number of hidden layers. In this example, the cRBM achieved accuracies of between 94.6% and 95.4%. Fuzzy RBMs reached accuracies between 94.6% and 95.7% when trained with 1000 hidden units (either divided into ten 100-deep classifiers or treated as on large one of 1000 layers). This accuracy is comparable to a 2-layer Neural Network. cRBMs, according to embodiments of the present systems and methods, use a significantly smaller number of hidden layers to achieve similar accuracy to the earlier work. FIG. 3 illustrates sample of digits from the MNIST data set for the original data followed by reconstructions with 40, 60, 80, 100, 120, 140, 160, 180, and 200 hidden layers. The cRBM was trained on the standard training set and the reconstructions are from the testing set. Table 3 shows the results for the cRBM, according to embodiments of the present systems and methods, using a number of layers from 40 to 200. Note that the 40 layers used in the cRBM is much smaller than the 1000 layers used in the dRBM. In this example, the classification accuracy degrades as the number of hidden layers rises, while the quality of the reconstruction shown in FIG. 3 improves. Accordingly, embodiments may include classification methods used on the hidden layers having improved quality.

TABLE 3

| Number of hidden layers | Accuracy |
|---|---|
| 40 | 95.4 |
| 80 | 95.2 |
| 100 | 94.6 |
| 200 | 91.8 |

In embodiments, the code may be written, for example, in C++ and complied with the GNU compiler. Other than the MNIST benchmark, in embodiments the calculations may be performed, for example, on a small laptop computer (such as al 0.6 GHz lenovo n22, using Ubuntu under windows 10) in a matter of minutes. The exact times depend on training parameters, but the cited examples from Table 3 took 205 seconds for the microRNA set with 50 hidden layers and 60 seconds for the shuttle set with 10 hidden layers. The MNIST data took about an hour of CPU time per point on a 1.6 GHz Linux workstation. Ten training epochs were used in all the examples.

Embodiments of the present systems and methods may provide effective techniques for classification and reconstruction using a continuous RBM. The accuracy of the predictions may be competitive with conventional methods when validated either against standard test sets or by 5-fold cross validation. In embodiments, the naive 1-NN classification method may be replaced with a more accurate one, and the mechanics of the least square estimation of H may be implemented in a more efficient manner. In embodiments, the techniques may be implemented on a GPU with significant performance enhancement.

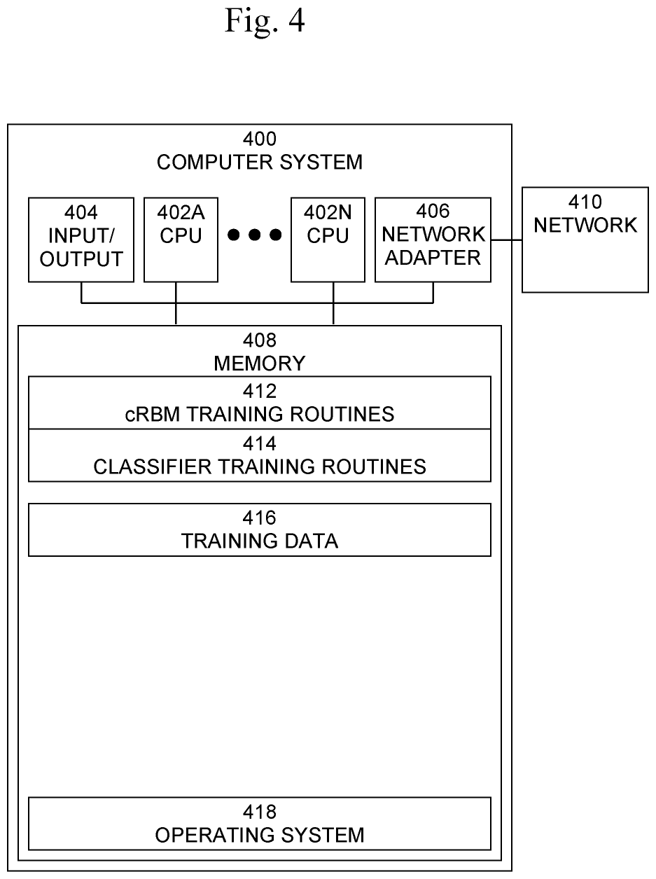

An exemplary block diagram of a computer system 402, in which processes involved in the embodiments described herein may be implemented, is shown in FIG. 4. Computer system 402 may be implemented using one or more programmed general-purpose computer systems, such as embedded processors, systems on a chip, personal computers, workstations, server systems, and minicomputers or mainframe computers, or in distributed, networked computing environments. Computer system 402 may include one or more processors (CPUs) 402A-402N, input/output circuitry 404, network adapter 406, and memory 408. CPUs 402A-402N execute program instructions in order to carry out the functions of the present communications systems and methods. Typically, CPUs 402A-402N are one or more microprocessors, such as an INTEL CORE® processor. FIG. 4 illustrates an embodiment in which computer system 402 is implemented as a single multi-processor computer system, in which multiple processors 402A-402N share system resources, such as memory 408, input/output circuitry 404, and network adapter 406. However, the present communications systems and methods also include embodiments in which computer system 402 is implemented as a plurality of networked computer systems, which may be single-processor computer systems, multi-processor computer systems, or a mix thereof.

Input/output circuitry 404 provides the capability to input data to, or output data from, computer system 402. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of computer system 402. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 may vary depending upon the function that computer system 402 is programmed to perform. In the example shown in FIG. 4, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 4, memory 408 may include cRBM training routines 412, classifier training routines 414, training data 416, and operating system 418. cRBM training routines 412 may include software routines to perform cRBM training, for example, as shown in FIG. 1. Classifier training routines 414 may include software routines to perform classifier training, for example, as shown in FIG. 2. Training data 416 may include one or more datasets that may be used for cRBM training and/or classifier training, as described above. Operating system 418 may provide overall system functionality.

As shown in FIG. 4, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for machine learning, the method comprising:
generating a continuous restricted Boltzman machine model by replacing discrete valued spins in a discrete restricted Boltzman machine model with continuous values;
training the continuous restricted Boltzman machine model using a training dataset using a deterministic training process having hidden variables defined using least square error estimates; and
using the trained continuous restricted Boltzman machine model to recognize patterns in new data.

2. The method of claim 1, wherein training the continuous restricted Boltzman machine model comprises:
generating initial values of weights of the continuous restricted Boltzman machine model;
generating initial values of the hidden variables based on the training dataset and visible values;
updating the values of the hidden variables based on a least squares error estimate of a distance from each hidden value to a predicted value of the hidden value and a visible value, given the weights; and
updating the weights using an integral over changes in potential.

3. The method of claim 2, wherein the integral over changes in potential is:
$$〈 \frac{d U}{dW} 〉 = dW \frac{3 {e}^{- β U ( W + d W )}}{{e}^{- β U ( W - dW )} + {e}^{- β U ( W )} + {e}^{- β U ( w + d W )}} ,$$
where W are the weights.

4. A system for machine learning, the system comprising a processor, memory accessible by the processor, and computer program instructions stored in the memory and executable by the processor to perform:
generating a continuous restricted Boltzman machine model by replacing discrete valued spins in a discrete restricted Boltzman machine model with continuous values;
training the continuous restricted Boltzman machine model using a training dataset using a deterministic training process having hidden variables defined using least square error estimates; and
using the trained continuous restricted Boltzman machine model to recognize patterns in new data.

5. The system of claim 4, wherein training the continuous restricted Boltzman machine model comprises:
generating initial values of weights of the continuous restricted Boltzman machine model;
generating initial values of the hidden variables based on the training dataset and visible values;
updating the values of the hidden variables based on a least squares error estimate of a distance from each hidden value to a predicted value of the hidden value and a visible value, given the weights; and
updating the weights using an integral over changes in potential.

6. The system of claim 5, wherein the integral over changes in potential is:
$$〈 \frac{d U}{dW} 〉 = dW \frac{3 {e}^{- β U ( W + d W )}}{{e}^{- β U ( W - dW )} + {e}^{- β U ( W )} + {e}^{- β U ( w + d W )}} ,$$
where W are the weights.

7. A computer program product for machine learning, the computer program product comprising a non-transitory computer readable storage having program instructions embodied therewith, the program instructions executable by a computer, to cause the computer to perform a method comprising:
generating a continuous restricted Boltzman machine model by replacing discrete valued spins in a discrete restricted Boltzman machine model with continuous values;
training the continuous restricted Boltzman machine model using a training dataset using a deterministic training process having hidden variables defined using least square error estimates; and
using the trained continuous restricted Boltzman machine model to recognize patterns in new data.

8. The computer program product of claim 7, wherein training the continuous restricted Boltzman machine model comprises:
generating initial values of weights of the continuous restricted Boltzman machine model;
generating initial values of the hidden variables based on the training dataset and visible values;
updating the values of the hidden variables based on a least squares error estimate of a distance from each hidden value to a predicted value of the hidden value and a visible value, given the weights; and
updating the weights using an integral over changes in potential.

9. The computer program product of claim 8, wherein the integral over changes in potential is:
$$〈 \frac{d U}{dW} 〉 = dW \frac{3 {e}^{- β U ( W + d W )}}{{e}^{- β U ( W - dW )} + {e}^{- β U ( W )} + {e}^{- β U ( w + d W )}} ,$$
where W are the weights.
